(19) United States
(12) Patent Application Publication
(10) Pub. No.: US 2023/0193950 A1
(43) Pub. Date: Jun. 22, 2023

(54) PLAIN BEARING, NOTABLY FOR AEROSPACE APPLICATIONS, HAVING IMPROVED WEAR RESISTANCE

(71) Applicant: AKTIEBOLAGET SKF, Goteborg (SE)

(72) Inventors: Joanna Stefania DZWONCZYK, Ijsselstein (NL); Grant James DENNIS, Pontypridd (GB); Michael Brett COLTON, Bristol (GB)

(21) Appl. No.: 17/991,158

(22) Filed: Nov. 21, 2022

(30) Foreign Application Priority Data
Dec. 20, 2021 (EP) 21215944.6

(51) Int. Cl. F16C 11/06

(52) U.S. Cl. CPC F16C 11/068

(57) ABSTRACT

A plain bearing includes an outer ring having an inner surface and an inner ring having an outer surface in contact with the inner surface of the outer ring. The inner ring is configured to cooperate with the outer ring to permit relative movement, and the inner ring or the outer ring or the inner ring and the outer ring is made of a metal matrix composite material.

### CROSS-REFERENCE

This application claims priority to European patent application no. 21215944.6 filed on Dec. 20, 2021, the contents of which are fully incorporated herein by reference.

### TECHNOLOGICAL FIELD

The present disclosure generally relates to plain bearings and more specifically to of plain bearings having improved wear resistance that are particularly suitable for aerospace applications.

### BACKGROUND

Typically in self-lubricating plain bearings, hard materials such as steel, or hard coatings such as ceramics, are used coupled with a self-lubricating material. The combination results in an optimized wear and friction resistance at the interface between the inner ring and the outer ring of the plain bearing.

The self-lubricating material is usually provided as a liner and is considered as a consumable material, whereas the opposing counter-surface is optimized to have no or very low wear.

In order to comply with weight reduction requirements of the aerospace industry, heavy materials of plain bearings such as steel are being replaced by light alloys. Light alloys, however, have poor tribological properties, especially when used as a countersurface that rubs against a composite self-lubricating liner. For example, under very low loads, aluminum alloy exhibits abrasive wear after very few oscillating cycles.

It is known to apply hard coatings to a surface using surface treatment methods such as Physical Vapor Deposition (PVD) or High Velocity Oxy Fuel (HVOF) to enhance the lifetime of plain bearings made of steel and light alloys such as titanium. Nevertheless, coatings obtained by HVOF or PVD techniques cannot be applied to certain light alloys as a substrate, such as aluminum, since the high process temperatures of these methods would lead to overaging the material and thus adversely affect its mechanical properties.

Because PVD and HVOF techniques are not suitable for aluminum light alloys, it is possible to form an electrochemically produced layer of aluminum oxide on the surface of aluminum alloy by a hard anodizing method. The resulting coating improves the wear resistance of the aluminum alloy. The downside of this solution is that the wear resistance of the coated aluminum alloy still remains low as compared with coated steels.

### SUMMARY

The present disclosure overcomes these disadvantages by providing a plain bearing suitable for aerospace applications that has an improved wear resistance that can be obtained from light alloys such as aluminum having limited thermal resistance properties.

One aspect of the disclosure is to provide a plain bearing, notably for aerospace applications, comprising an outer ring and an inner ring comprising respectively an inner surface and an outer surface intended to cooperate with each other for the relative movement of the outer and inner rings.

In a first embodiment, the inner ring is made of a metal matrix composite material.

In a second embodiment, the outer ring is made of a metal matrix composite material.

In a third embodiment, the inner and outer rings are each made of a metal matrix composite material.

According to an embodiment, the metal matrix composite material may comprise an aluminum alloy matrix. Advantageously, the major alloying element of the aluminum matrix may be copper, zinc or a combination of magnesium and silicon.

Preferably, the metal matrix composite material is reinforced with ceramic fillers. According to an embodiment, the ceramic fillers comprise silicon carbide particles. More preferably, the particle size of silicon carbide is comprised between 0.7 µm and 3 µm. More preferably, the volume fraction of the silicon carbide fillers is comprised between 15% and 28%.

Advantageously, the plain bearing further comprises a self-lubricating liner interposed between the inner surface of the outer ring and the outer surface of the inner ring. In this case, the plain bearing is a self-lubricating plain bearing. Advantageously, the liner comprises a phenolic resin matrix filled with glass fibers. Advantageously, the plain bearing may be a spherical plain bearing. In this case, the inner surface of the outer ring is concave and the outer surface of the inner ring is convex.

### BRIEF DESCRIPTION OF THE DRAWINGS

Other advantages and features of the disclosure will appear from the detailed description of embodiment of the invention, which are non-limiting example, illustrated on the appended drawing of which:

FIG. 1 is a perspective view of a spherical plain bearing according to an embodiment of the disclosure.

### DETAILED DESCRIPTION

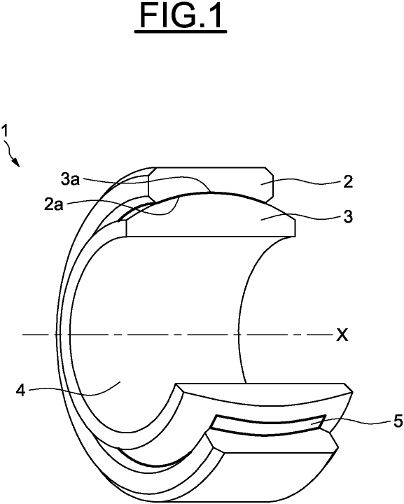

Referring to FIG. 1, a spherical plain bearing 1 having a main axis of rotation X includes an outer ring 2 concentrically positioned with respect to an inner ring 3. The exemplified plain bearing 1 is a lightweight plain bearing for aerospace applications.

The outer ring 2 has a concave bore or inner surface 2a of spherical shape, and the inner ring 3 has a convex outer surface 3a of spherical shape. The inner ring 3 also has a cylindrical bore 4.

The inner and outer surfaces 2a, 3a are facing each other and are of corresponding shapes to permit a relative motion between them the outer ring 2 and the inner ring 3.

In the illustrated example, the plain bearing 1 is a self-lubricating plain bearing. The plain bearing 1 comprises a self-lubricating liner 5 radially interposed between the inner surface 2a of the outer ring 2 and the outer surface 3a of the inner ring 3. The self-lubricating liner 5 reduces friction and permits a reduced wear rate during the service life of the plain bearing 1.

The liner 5 may be in the form of a sheet and attached to either the inner surface 2a of the outer ring 2 or the outer surface 3a of the inner ring 3. In the illustrated example, the liner 5 is fixed to the inner surface 2a of the outer ring 2 and has a sliding contact surface facing the outer surface 3a of the inner ring 3. The outer ring 3 radially contacts the inner ring 2 via the liner 5.

The liner 5 may comprise a composite material, for example a phenolic resin matrix filled with glass fibers. The liner 5 may also comprise a polyurethane resin, for example a F160® resin. Furthermore, the inner ring 3 comprises a metal matrix composite material.

In another embodiment, the plain bearing 1 may include an outer ring 2 or a combination of an inner ring 3 and an outer ring 2 comprising a metal matrix composite material.

In the illustrated embodiment, the metal matrix composite material comprises an aluminum alloy matrix. The major alloying element of the aluminum matrix is preferably copper, or zinc, or a combination of magnesium and silicon. In particular, the aluminum-based alloys from 2/6/7xxx series may be selected. The aluminum alloy matrix can be, for example, AA2124 alloy. Aluminum alloys are light alloys particularly suitable for aerospace applications. In another embodiment, the inner ring 3 and/or the outer ring 2 can be made from a different light alloy matrix such as, for example, titanium alloy or magnesium alloy.

The illustrated outer ring 2 is made of aluminum alloy. An example of aluminum alloy is AA2124 alloy.

Preferably, the metal matrix composite material is reinforced with ceramic fillers, for example with silicon carbide particles. More preferably, the particle size of silicon carbide is comprised between 0.7 µm and 3 µm and the volume fraction of the silicon carbide fillers is comprised between 15% and 28%. The aluminum alloy matrix composite can be, for example, AMC225XE material incorporating a volume fraction of 25% of silicon carbide.

The incorporation of hard ceramic fillers in the aluminum alloy matrix increases the macro surface hardness of the aluminum alloy matrix. As a result, the inner ring 3 made of silicon carbide particles exhibits a greater resistance to wear.

Besides, the presence of ceramic fillers improves the wear resistance of the inner ring 3 which may be subjected to friction against the hard sliding contact surface of the liner 5 especially when the liner 6 includes hard filler particles such as glass fibers. Therefore, the resulting self-lubricating plain bearing 1 exhibits a better mechanical resistance, improved wear properties of the self-lubricating liner 5 and, consequently, an extended service life.

In particular, an inner ring 3 comprising ceramic fillers in an aluminum alloy matrix shows a significantly better hardness and resistance to wear than uncoated aluminum alloy such as, for example, AA7075 aluminum alloy. It was also found that such an inner ring 3 gives a greater resistance to wear than steel-based plain bearings.

This permits the use of lightweight materials without the need for an additional manufacturing step to apply a coating. Consequently, the cost of manufacturing the plain bearing is reduced compared with alternative coated solutions. The use of a metal matrix composite material makes it possible to manufacture a lightweight plain bearing based on light alloy suitable for aerospace with a service life at least equal to a plain bearing based on steel.

According to an embodiment, a coating can be applied, in addition, on the inner surface 2a of the outer ring 2 or on the outer surface 3a of the inner ring 3 in order to further improve friction resistance, wear resistance and/or corrosion resistance of the ring to which the coating is applied.

In the illustrated example, the plain bearing is a self-lubricating plain bearing provided with the liner. Alternatively, the plain bearing may not be provided with the liner. In this case, the outer ring 2 radially comes into direct contact against the inner ring 3.

In the illustrated example, the plain bearing is a radial spherical plain bearing. Alternatively, the plain bearing may be an angular contact spherical plain bearing or a thrust spherical plain bearing. In another embodiment, the plain bearing may be a cylindrical plain bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved plain bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A plain bearing comprising:
an outer ring having an inner surface; and
an inner ring having an outer surface in contact with the inner surface of the outer ring,
wherein the inner ring is configured to cooperate with the outer ring to permit relative movement, and
wherein the inner ring or the outer ring or the inner ring and the outer ring is made of a metal matrix composite material.

2. The plain bearing according to claim 1, wherein the metal matrix composite material comprises an aluminum alloy matrix.

3. The plain bearing according to claim 2, wherein a major alloying element of the aluminum alloy matrix is copper or zinc or a combination of magnesium and silicon.

4. The plain bearing according to claim 1, wherein the metal matrix composite material is reinforced with ceramic fillers.

5. The plain bearing according to claim 4, wherein the ceramic fillers comprise silicon carbide particles.

6. The plain bearing according to claim 5, wherein a particle size of the silicon carbide particles is between 0.7 µm and 3 µm.

7. The plain bearing according to claim 5, wherein a volume fraction of the silicon carbide particles is between 15% and 28%.

8. The plain bearing according to claim 1, including a self-lubricating liner between the inner surface of the outer ring and the outer surface of the inner ring .

9. The plain bearing according to claim 8, wherein the liner comprises a phenolic resin matrix filled with glass fibers.

10. The plain bearing according to claim 1, wherein the inner surface of the outer ring is concave and the outer surface of the inner ring is convex.

11. The plain bearing according to claim 1,
wherein the inner surface of the outer ring is concave and the outer surface of the inner ring is convex,
wherein the metal matrix comprises an aluminum alloy matrix reinforced with silicon carbide particles, and
wherein a major alloying element of the aluminum alloy matrix is copper or zinc or a combination of magnesium and silicon.

12. The plain bearing according to claim 11,
including a glass fiber reinforced phenolic resin matrix liner between the inner ring and the outer ring.
